(19) United States
(12) Patent Application Publication
(10) Pub. No.: US 2004/0222629 A1
(43) Pub. Date: Nov. 11, 2004

(54) Fluid line connector system

(75) Inventors: Timothy Tiller, Blue River, WI (US); Floyd I. Baker, Readstown, WI (US); David Roethel, La Farge, WI (US)

Correspondence Address: HELLER EHRMAN WHITE & MCAULIFFE LLP, 1666 K STREET,NW, SUITE 300, WASHINGTON, DC, 20006, US

(73) Assignee: S & S Cycle, Inc.

(21) Appl. No.: 10/429,672

(22) Filed: May 5, 2003

(51) Int. Cl. F16L 27/04

(52) U.S. Cl. 285/136.1

(57) ABSTRACT

A fluid line connector system provides for connecting a fluid line to an article such as a fluid chamber. The wall of the fluid chamber has an orifice formed therein with a threaded portion. A fitting has a body with a hexagonal passage extending there through. A first end portion includes an interior tool receiving profile having a substantially hexagonal profile. A second end includes threads configured for inserting into the orifice. An exterior of the first end portion includes a raised ridge over which a fluid line is attached. A clamp engages the fluid line over the fitting and retains the connection in place.

### BACKGROUND OF THE INVENTION

1. Field of the Invention

The present invention relates to a fluid line connector system and in particular to a fitting that provides easier connection and more precise positioning for a connected fluid line.

2. Description of the Prior Art

Hose fittings such as those used to connect various types of fluid lines, such as for example, an oil line mounting to a structure such as an engine block, are well known. Such hose fittings typically include a threaded portion that screws into a complementary threaded orifice in the wall of the structure. The end of the hose typically slides over the exposed portion of the fitting.

Referring to FIGS. 1-4, a typical fluid line connector system of the prior art is shown. As shown in FIGS. 1 and 2, the fitting includes a first end with a threaded exterior and a second end that receives a hose. A hexagonal tool receiving exterior section configured for accepting a wrench or socket, is typically formed intermediate the threaded portion and the hose receiving portion. The hose receiving end has an annular ridge extending around the periphery of the fitting to aid in retaining the hose on the fitting. As shown in FIGS. 3 and 4, the ridge has a greater diameter, thereby forming a narrowed diameter neck portion so that when a clamp is placed on the hose, the clamped hose cannot slide off on the smaller diameter neck portion between the ridge and the tool receiving section.

Referring again to FIGS. 3 and 4, one of the problems with such a prior art fitting is the variability in the distance D between the wall of the structure to which the hose is being attached and the end of the hose. As the depth to which the threaded hole is tapped may vary, the distance that the fitting is inserted into the wall also varies. As the hose may or may not be pushed onto the fitting up to the tool engagement hex portion or a lesser distance, the distance D will vary depending on the depth to which the fitting is inserted. For some applications with very tight tolerances, the variance in D requires using hoses of different lengths or trimming the length of the hose, adding time and expense.

It can also be appreciated that the fitting may often be in a location in which it is difficult to access the exterior tool receiving section with a wrench fitting on the outside. The length of the fitting may also make it difficult to properly place a socket over the exterior of the fitting.

As shown in FIG. 3 and 4, as the hose does not cover the entire outer surface of the fitting, leaving exposed portions, it is often desired that such exposed portions be polished or made of a material that is aesthetically pleasing. Therefore, the material used for the fitting may often be brass or other material that is more expensive than the material needed if the entire piece is hidden. In addition, for some applications, a chrome or polished treatment may be necessary to blend in with the rest of the components to which it mounts, further increasing expense.

It can be seen then that a new and improved connector system is needed. Such a connector system should provide for secure and easy attachment of a fluid line to a receiving structure. Moreover, such a system should provide a fitting that eliminates the exterior hexagonal portion. The connector system should also hide the fitting when mounted and provide a constant fluid line length. The present invention addresses these as well as other problems associated with fluid line connector systems.

### SUMMARY OF THE INVENTION

The present invention is directed to a connector system and in particular to a fluid line connector with a fitting that provides for an attached fluid line completely covering the fitting.

The chamber or reservoir housing, or other structure to which the fluid line is connected has an orifice formed through its wall. The orifice includes at least a threaded outermost section configured for receiving a complementary threaded fitting.

The fitting includes a first end portion and a second end portion. The second end portion includes threads configured for inserting into the orifice and screwing into the threaded portion. One of the first or second ends includes an interior tool receiving portion. The interior tool receiving portion has a hexagonal inner profile in one embodiment. The hexagonal profile can receive an Allen Wrench from the first or second end. Alternatively, the tool receiving portion may have a different profile for receiving other well known tool shapes without blocking the through passage of the fitting. The exterior of the first end portion is generally cylindrical with an annular ridge extending around the periphery of the first end portions spaced slightly inward from the first end. When assembled, the fluid line slides over the first end and may cover any exposed fitting threads. A retainer such as a hose clamp attaches to the fluid line over the fitting between the wall and the ridge. The clamp prevents the fluid line from sliding off of the fitting.

To assemble the connector system, an actuator tool is inserted into the tool receiving portion of the fitting and the fitting is screwed into the orifice in the structure's wall. The tool is removed and the fluid line is slid over the fitting until it substantially abuts the wall. The hose clamp is then tightened down onto the fluid line between the raised ridge and the wall. As the fitting does not have a hexagonal portion or other structure needed for a tool extending outward from the fitting, the fluid line may be slid to abut the wall if desired and easily removed, unlike the prior art.

These features of novelty and various other advantages which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

Referring now to the drawings, wherein like reference numerals and letters indicate corresponding structure throughout the several views:

FIG. 1 shows a perspective view of a prior art hose fitting having an exterior hexagon profile section;

FIG. 2 shows a side elevational view of the prior art hose fitting shown in FIG. 1;

FIG. 3 shows a perspective view of a prior art connector system including the fitting of FIG. 1 mounted to the wall of a chamber and having a hose attached;

FIG. 4 shows a side elevational view of the prior art connector system shown in FIG. 3;

FIG. 5 is a perspective view of a fluid line connector system according to the principles of the present invention;

FIG. 6 is a side sectional view of the fluid line connector system shown in FIG. 5;

FIG. 7 is a side elevational view of the fluid line connector system shown in FIG. 5;

FIG. 8 is an end view of the fluid line connector system shown in FIG. 5;

FIG. 9 is a side elevational view of a first embodiment of a fitting for the connector system shown in FIG. 5;

FIG. 10 is an end view of the fitting shown in FIG. 9;

FIG. 11 is a side sectional view of the fitting shown in FIG. 10 taken along line 11-11; and

FIG. 12 is a side sectional view of a second embodiment of a fitting for the connector system shown in FIG. 5.

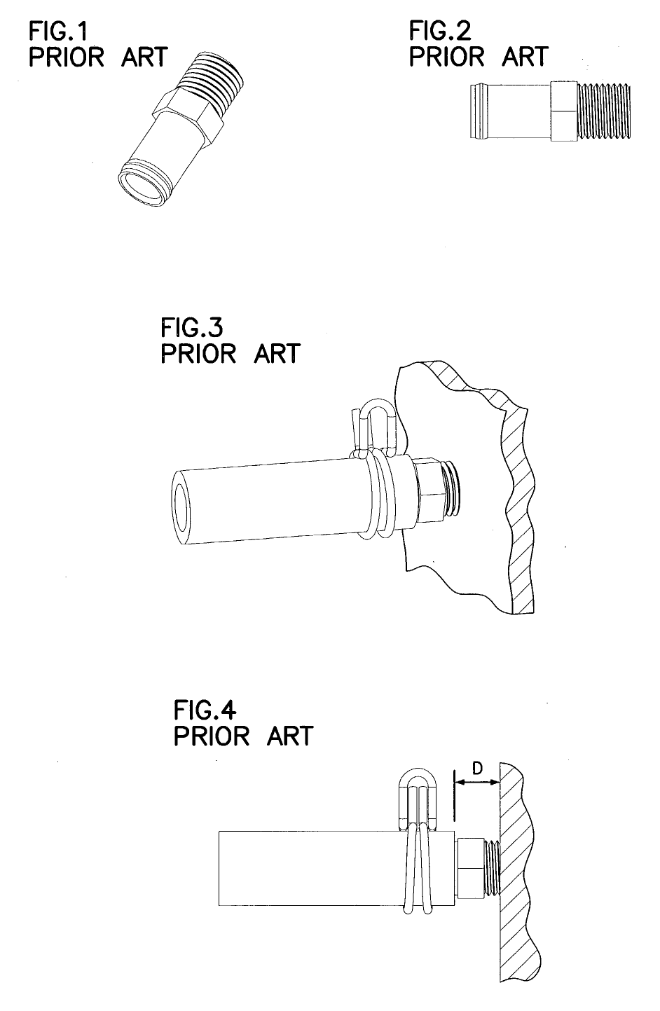

### DETAILED DESCRIPTION OF THE PREFERRED EMBODIMENTS

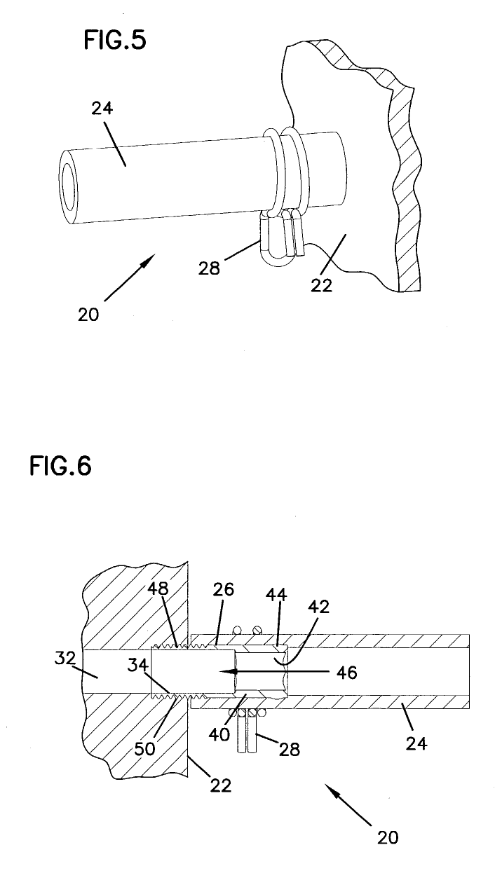

Referring now to the drawings, and in particular to FIGS. 5-8, there is shown a connector system, generally designated 20. The connector system 20 attaches a fluid line 24 to a housing 22 for a chamber of a structure, such as an internal combustion engine sump. However, other uses for connecting fluid lines into a wall of a structure for other types of fluids in other well known applications are also contemplated within the principles of the present invention. The connector system 20 includes a fitting as shown in FIG. 6 and FIGS. 8-12. A fluid line retainer 28 engages the fluid line 24 and retains the fluid line 24 on the fitting, as shown in FIGS. 5-8.

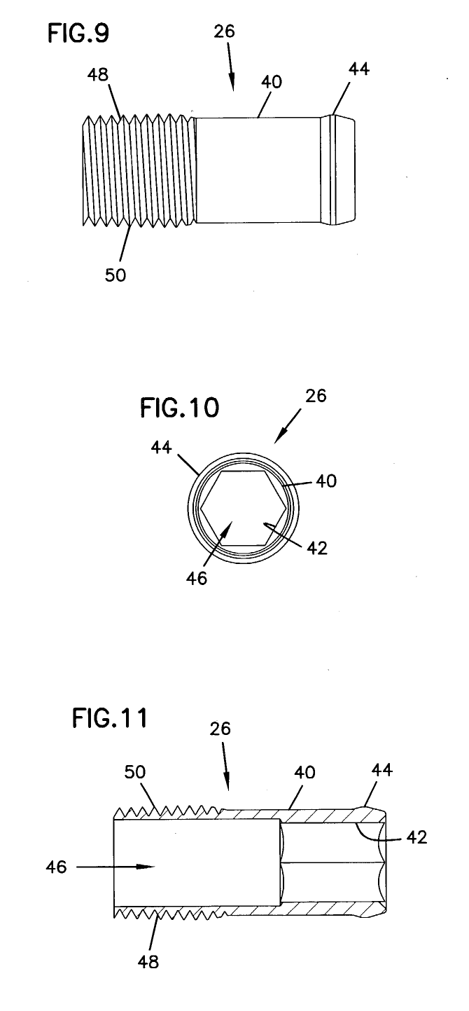

Referring now to FIGS. 9 and 11, a first embodiment of a fitting 26 includes a first end portion 40 and a second end portion 48. The fitting 26 includes a through passage 46 extending axially entirely through the fitting 26. The first end portion 40 is generally cylindrical and includes a ridge 44 extending around the periphery of the first end portion 40 spaced apart from the end and transverse to the axial direction of the fitting 26. The ridge 44 provides a stop to prevent the fluid line from sliding off of the fitting 26 when clamped, as explained hereinafter. As shown in FIGS. 10 and 11, the interior of the first end portion includes a hexagonal profile 42 in one embodiment. The hexagonal profile 42 allows a sufficient cross sectional area to maintain acceptable fluid flow. In addition, the hexagonal interior profile allows for acceptance of an Allen Wrench or other tool to engage the fitting 26 and twist it into the orifice 32.

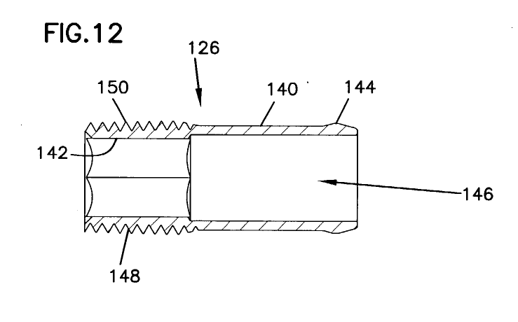

In FIG. 12 a second embodiment of a fitting, designated 126 is shown. The fitting 126 is similar to and interchangeable with the fitting 26 shown in FIGS. 9-11, except for the placement of the tool receiving portion. The fitting 126 includes a first end portion 140 and a second end portion 148. The fitting 126 includes a through passage 146 extending axially entirely through the fitting 126. The first end portion 140 is generally cylindrical and includes a ridge 144 extending around the periphery of the first end portion 140 spaced apart from the end and transverse to the axial direction of the fitting 126. The ridge 144 provides a stop to prevent the fluid line from sliding off of the fitting 126 when clamped, as explained hereinafter. The exterior of the second end portion 148 includes threads 150 interior of the second end portion 148 includes a hexagonal profile 142 in one embodiment, although other tool receiving profiles are possible, as explained hereinafter. The placement of the tool receiving portion 142 allows for access by an actuator tool from the second end of the fitting. Depending upon the application and access available, actuation from either end of the fitting is possible by choosing either fitting 26 or 126. Although reference will be made to the fitting 26 and its features in the description that follows, it is understood that the fitting 126 and its features may be interchanged with the fitting 26.

Referring now to FIG. 6, the wall of the structure 22 includes an orifice 32 formed there through. An outer portion of the exterior facing end of the orifice 32 includes a threaded section 34, which is complementary to the fitting 26, as explained hereinafter. In this manner, the fitting is simply twisted into the orifice 32 and is securely, yet removably retained.

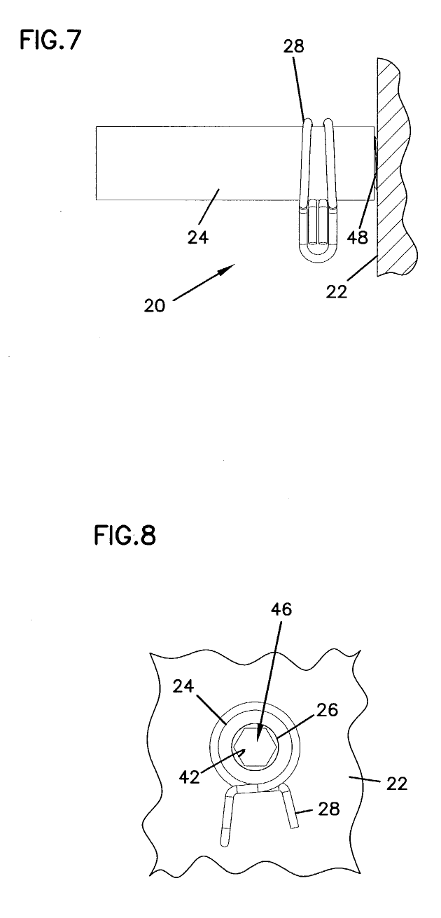

Although a hexagonal profile is shown in the embodiments illustrated, other interior profiles such as a square, torx, eight or twelve sided profiles, and other common tool shapes well known in the art may also be utilized. With the tool engaging portion 42 (or 142) positioned at the interior of the fitting in the through passage 46, the hexagonal exterior portion that protrudes outward in the prior art is eliminated, allowing for the fluid line 24 to be slid over the entire length of the fitting 26 and to substantially abut the wall of the chamber 22 if desired, as shown in FIGS. 6 and 7.

As shown in FIGS. 6, 9 and 11, the second end portion 48 includes exterior threads 50. The exterior threads 50 are configured for screwing into the threaded portion 34 of the orifice 32 for secure releasable engagement between the fitting 26 and the orifice 32. The fitting 26 includes a smooth substantially cylindrical exterior surface. The ridge 44 does not have a sharp corner or point and allows the fluid line 24 to slide over it. The remainder of the cylindrical exterior is free of obstructions so that the fluid line 24 is easily inserted onto the entire length of the fitting 26 if necessary. This overcomes the problem of an exterior hexagonal section for engagement by sockets, wrenches or other tools that prevents the hose from being slid over the entire fitting. Moreover, as shown in FIGS. 5-7, the fluid line 24 is slid onto the fitting 26 such that it may abut the exterior wall portion 22. With this configuration, the length of fluid line 24 that is needed remains constant rather than varying according to the depth of the threads and the orifice, as the space between the structure 22 and the end of the fluid line 24 of prior art connector systems, shown as distance D in FIG. 4, is eliminated.

To mount the fitting 26 in the orifice 32, a tool such as a hexagonal Allen Wrench is inserted into the first end to engage the hexagonal profile interior portion 42. The fitting 26 is then aligned with the orifice such that the threads 50 and 34 engage. The tool and fitting 26 are then twisted until the fitting is screwed into the orifice 32 until reaching a desired depth, typically until engaging the end of the threaded portion 34 of the orifice 32, as shown in FIG. 6.

When the fitting 26 has been inserted, the fluid line retaining clamp 28 is slid over the fluid line 24. The handle portions of the clamp 28 are pressed together to increase the size of the opening in the retainer 28, thereby loosening the clamp 28. The fluid line 24 is slid onto the fitting 26 until it substantially abuts the wall 22. The retainer clamp 28 is then slid along the fluid line 24 over the fitting 26 and past the outer ridge 44 to the position shown in FIGS. 5-7. The handle portions of the retaining clamp 28 are then released and the retaining clamp 28 compresses the fluid line 24 tightly against the fitting 26 so that it had a narrower diameter than the ridge 44. The retaining clamp 28 is clamped down with sufficient force that the fluid line 24 and the clamp 28 cannot slide over the annular ridge 44 at the outer first end portion 40 of the fitting 26. Although the fitting 26 and fluid line 24 are securely attached, by simply releasing the retainer 28, the fluid line 24 may be removed by sliding directly off the fitting 26. In addition, once the fluid line 24 is removed from the fitting 26, the fitting 26 may also be easily unscrewed from the orifice 32. This allows for quick and simple removal and replacement, should parts fail, such as may occur if the fluid line 24 is torn or punctured. In addition, the fluid line 24 has a constant length regardless of the depth to which the fitting 26 is inserted and is positioned at the same location for every like application, providing improved tolerances.

These features of novelty and various other advantages that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

1. A fitting for coupling a line to a threaded article, comprising:
a first end portion extending from a first end;
a second end portion extending from a second end, the second end portion including a threaded connector portion adapted and configured to couple with the threaded article;
an inner axial passage including a tool receiving inner profile extending from one of the first end portion and the second end portion; and
a ridge formed on the first end portion,
wherein the fitting is adapted to couple with the line by inserting the first end portion into an end of the line such that an inner surface of the line applies a compressive force on the ridge to retain the fitting within the line.

2. A fitting according to claim 1, wherein the tool receiving inner profile comprises a hexagon.

3. A fitting according to claim 1, wherein the ridge extends substantially around a periphery of the first end.

4. A fitting according to claim 1, wherein the ridge is spaced apart from the first end.

5. A fitting according to claim 1, wherein the tool receiving inner profile is proximate the first end.

6. A fitting according to claim 1, wherein the tool receiving inner profile is proximate the second end.

7. A fluid line and connector assembly for coupling the fluid line to a threaded article, comprising:
a fitting, comprised of:
a first end portion extending from a first end;
a second end portion extending from a second end, the second end portion including a threaded connector portion adapted and configured to couple with the threaded article; and
an inner axial passage including a tool receiving profile extending from one of the first end portion and the second end portion; and
a ridge formed on the first end portion; and
a fluid line retainer for engaging the fluid line to prevent removal of the fluid line from the fitting,
wherein the fluid line has an interior passageway configured for sliding an end of the fluid line over the first end portion of the fitting.

8. A fluid line and connector assembly according to claim 7, wherein the tool receiving profile comprises a hexagon.

9. A fluid line and connector assembly according to claim 7, wherein the ridge extends substantially around a periphery of the first end portion.

10. A fluid line and connector assembly according to claim 7, wherein the ridge is spaced apart from the first end.

11. A fluid line and connector assembly according to claim 7, wherein the tool receiving inner profile is proximate the first end.

12. A fluid line and connector assembly according to claim 7, wherein the tool receiving inner profile is proximate the second end.

13. A hose fitting for coupling a hose to a threaded article, comprising:
a body defining an axial passage with a first end portion extending from a first end, and a second end portion extending from a second end,
wherein the first end portion has an interior surface defining an opening having a hexagonal profile, and a cylindrical exterior surface with a ridge extending substantially around a periphery of the first end portion,
wherein the second end portion comprises a threaded connector portion adapted and configured to couple with the threaded article, and
wherein the hose fitting is adapted to couple with the hose by inserting the first end portion into an end of the hose such that an inner surface of the hose applies a compressive force on the ridge to retain the fitting within the hose.

14. A fitting according to claim 13, wherein the threaded connector comprises an exterior thread.

15. A fitting according to claim 13, wherein the ridge is spaced apart from the first end.

16. A system for connecting a fluid line to a first article, comprising:
a receiver portion of the first article defining a threaded orifice;
a fitting, comprised of:
a first end portion extending from a first end with a substantially round exterior surface;
a second end portion extending from a second end, the second end portion including a threaded connector portion for inserting into the orifice;
an inner axial passage including an interior surface defining an opening having a hexagonal profile; and
a ridge formed on the first end portion;
a fluid line having an end of an interior passageway adapted to slide over the first end portion of the fitting; and
a fluid line retainer adapted to engage the fluid line to prevent removal of the fluid line from the fitting.

17. A system according to claim 16, wherein the fluid line abuts the first article.

18. A system according to claim 16, wherein the fluid line retainer comprises a clamp.

19. A system according to claim 16, wherein the ridge extends substantially around a periphery of the fitting.

20. A system according to claim 19, wherein the fluid line abuts the first article.

21. A system according to claim 20, wherein the fluid line retainer comprises a clamp.

22. A system according to claim 20, wherein the ridge is spaced apart from the first end.

23. A system according to claim 22, wherein the fluid line retainer comprises a clamp mounted over the fluid line intermediate the ridge and the first article.

24. (Cancelled)

25. A method according to claim 32, wherein the fluid line is slid over the fitting until the fluid line abuts the article.

26. A method according to claim 32, wherein the fluid line retainer comprises a clamp.

27. A method according to claim 32, wherein the ridge extends substantially around a periphery of the fitting.

28. A method according to claim 27, wherein the fluid line is slide over the fitting until the fluid line abuts the article.

29. A method according to claim 28, wherein the fluid line retainer comprises a clamp.

30. A method according to claim 28, wherein the ridge is spaced apart from the first end.

31. A method according to claim 30, wherein the fluid line retainer comprises a clamp mounted over the fluid line intermediate the ridge and the article.

32. A method of connecting a fluid line to an article, comprising:
threading a first end portion of a fitting to a threaded orifice in the article;
engaging a tool receiving inner profile of the fitting so as to tighten the fitting sufficient to provide a fluid tight seal between the fitting and the article;
sliding an end of the fluid line over a ridge formed on a second end portion of the fitting such that an inner surface of the fluid line applies a compressive force on the ridge to retain the fitting in the fluid line; and
securing the fluid line to the fitting with a fluid line retainer.
